(19) United States
(12) Patent Application Publication
(10) Pub. No.: US 2026/0234050 A1
(43) Pub. Date: Aug. 13, 2026

(54) MELTING AND FIBERIZING RECYCLED ROCK WOOL

(71) Applicant: SAINT-GOBAIN ISOVER, COURBEVOIE (FR)

(72) Inventors: Elodie CHAUDAN, Courbevoie (FR); Frederic LOPEPE, Courbevoie (FR); Thibault GUILLET, Billesholm (SE); David BOUSQUET, Aubervilliers (FR)

(73) Assignee: SAINT-GOBAIN ISOVER, COURBEVOIE (FR)

(21) Appl. No.: 19/471,719

(22) PCT Filed: Mar. 29, 2024
(86) PCT No.: PCT/EP2024/058755

§ 371 Date: Oct. 2, 2025

(30) Foreign Application Priority Data
Apr. 3, 2023 (FR) 2303285

(51) Int. Cl. C03C 13/06; C03C 1/00; C03C 3/087; C03C 3/091

(52) U.S. Cl. CPC C03C 13/06; C03C 1/002; C03C 3/087; C03C 3/091; C03C 2201/10; C03C 2201/32; C03C 2201/40; C03C 2201/50; C03C 2201/54

(57) ABSTRACT

The invention relates to a composition of raw materials suitable for being loaded into a glass furnace, melted and then fiberized via internal centrifugation, which composition of raw materials comprises a rock wool recyclate. The invention also relates to methods for melting this composition and fiberizing same via internal centrifugation, and to the mineral wool obtained by means of these methods. The invention also relates to the use of a rock wool recyclate as a source of Al2O3, CaO and MgO for the manufacture of a mineral wool.

The present invention relates to a composition of raw materials suitable for being loaded into a glass furnace, melted and then fiberized via internal centrifugation, comprising a rock wool recyclate. The invention also relates to methods for melting this composition and fiberizing same via internal centrifugation, and to the mineral wool obtained by means of these methods. The invention also relates to the use of a rock wool recyclate as a source of Al₂O₃, CaO and MgO for the manufacture of a mineral wool.

It is known to “recycle” a mixture of mineral wool by making it melt in a glass furnace with a view to it to be fiberized again. Among the many advantages of such a recycling of mineral wool waste is the improvement of the energy efficiency of the glass furnace, as the collected mineral wool mixture is easier to melt than a “conventional” raw material composition comprising, among others, large quantities of silica.

Mineral wool is characterized by an entanglement of discontinuous fibers, which distinguishes it from continuous fibers generally used to reinforce organic or inorganic materials (for example cement). The mineral wool may comprise one or more types of fibers originating from their production (factory waste), for example from cutting and/or scrapping mats of mineral wool, or from building sites (construction site waste or demolition site waste) and/or from recycling channels allowing the recovery of such mineral fibers from end products, whether or not they have been used. Other types of materials can be combined with mineral fibers, for example paper, aluminum or bituminous films, or wooden pallet parts.

Such mineral fibers can in particular be obtained from raw materials traditionally used in the glass industry or from basaltic rocks. They are then known as glass wool and rock wool, respectively. These two types of mineral wool differ from each other by their composition, by their melting process, but also by the associated fiberizing method.

Within the meaning of the invention, a mineral wool has a chemical composition comprising the following constituents:
SiO2:30 to 75% by mass,
CaO+MgO: 5 to 45% by mass,
Al2O3: 0 to 30% by mass,
Na2O+K2O: 0 to 20% by mass,
Fe2O3: 0 to 20% by mass,
B2O3: 0 to 14% by mass,
MnO: 0 to 4% by mass.

The name “rock wool” generally refers to mineral wools with fibers whose chemical composition comprises the following constituents:
SiO2: 30 to 50% by mass,
Al2O3: 10 to 22% by mass,
CaO+MgO: 20 to 45% by mass,
Fe2O3: 0 to 20% by mass,
Na2O+K2O: 0 to 10% by mass,
B2O3: 0 to 1% by mass.

In contrast, the name “glass wool” generally refers to mineral wools with fibers whose chemical composition comprises the following constituents:
For so-called low-alumina glass wools:
SiO2: 50 to 75% by mass,
Al2O3: 0 to 8% by mass,
CaO+MgO: 5 to 20% by mass,
Fe2O3: 0 to 3% by mass,
Na2O+K2O: 6 to 20% by mass,
B2O3: 0 to 14% by mass,
MnO: 0 to 4% by mass;
For so-called high-alumina glass wools:
SiO2: 35 to 55% by mass,
Al2O3: 16 to 27% by mass,
CaO+MgO: 3 to 30% by mass,
Fe2O3: 0 to 15% by mass,
Na2O+K2O: 5 to 17% by mass,
B2O3: 0 to 5% by mass.

In the present application, the compositions are conventionally expressed in the form of oxides. In particular, if the (total) iron oxide content is expressed as Fe2O3, this does not mean that this iron oxide is necessarily and exclusively present in ferric form. Iron oxide can be present in both its ferric (Fe2O3) and ferrous (FeO) forms, and it is purely by convention that the total iron oxide content is referred to as Fe2O3.

Preferably, the sum of the mass concentrations of SiO2, Al2O3, CaO, MgO, Fe2O3, Na2O, K2O and MnO in the composition of raw materials according to the invention and in the wool compositions described in the present application is greater than or equal to 90%, or even greater than or equal to 95%.

It is understood that the mineral wools described hereinbefore may comprise other oxides, generally present in trace amounts, such as P2O5 or TiO2.

The melting of rock (basalt or blast furnace slag) generally requires heating the raw materials to temperatures significantly higher than the melting of so-called glass raw materials. Traditionally, this process is carried out in cupola furnaces, heated with large quantities of coke to temperatures of around 1500° C. Indeed, refractory furnaces, traditionally used for melting glass raw materials, cannot withstand the high temperatures required to melt rock.

Likewise, the fiberizing processes for these mineral wools depend directly on their respective composition, and are therefore not interchangeable.

Thus, the fiberizing method commonly used to produce rock fiber is the method known as external centrifugation. For this method, the material to be fiberized is poured in the molten state onto the peripheral tread of centrifuge wheels that are rotating, is accelerated by these wheels, becomes detached therefrom, and is partially transformed into fibers under the effect of centrifugal force, a gas stream being emitted tangentially to the peripheral tread of the wheels so as to pick up the fiberized material by separating it from the non-fiberized material and conveying it to a receiving member. Reference may be made, for example, to fiberizing by external centrifugation, in patent application EP195725.

Such a method of fiberizing the rock wool is to be distinguished from that commonly used to fiberize a glass wool (of the low-alumina or high-alumina type), referred to as a fiberizing method by internal centrifugation. It consists in introducing a net of the stretchable material in the molten state into a centrifuge, also called a fiberizing spinner, rotating at high speed. Such a fiberizing spinner may alternatively be equipped with a bottom and is pierced at its periphery by a very large number of orifices through which the material is sprayed in the form of filaments under the effect of centrifugal force. By means of a burner of annular shape, these filaments are then subjected to the action of a gaseous annular drawing current with a high temperature and speed (with the temperature potentially reaching 1000° C. or even 1200° C., and the speed 250 m/s, depending on the desired product) running along the wall of the centrifuge which thins them and transforms them into fibers.

There are therefore notable differences between rock wool and the glass wool, with regard to their composition, their melting process, the physical properties (resulting therefrom) from the molten material leaving the furnace (temperature, viscosity, etc.), and the associated fiberizing method. Regarding this latter aspect, it should be noted that a rock wool type composition cannot technically be fiberized by internal centrifugation, nor can a glass wool type composition technically be fiberized by external centrifugation.

With regard to these technical differences, and in the context of recycling used fibers, it is therefore natural for a person skilled in the art to dedicate the recycling of rock wool to the production of rock wool exclusively, and to dedicate the recycling of glass wool to the production of glass wool exclusively, without ever considering mixing these two distinct technical fields.

The strict partitioning existing between the use of the glass wool waste on the one hand, and the rock wool waste on the other hand, nevertheless has the disadvantage of complicating the associated supply channels, by increasing the number of storage locations and/or the transport distances or carrying out sorting before placing in the melting bath.

The claimed invention is intended to provide a technical solution to the disadvantages described hereinbefore. More particularly, in at least one embodiment, the proposed technique relates to a composition of raw materials adapted to be melted and fiberized by internal centrifugation to obtain a mineral wool, in particular glass wool, characterized in that said raw material composition comprises from 1% to 50% (for example from 1% to 40%, or even from 10% to 40%) by mass of rock wool recyclate.

For the purposes of the invention, a composition of raw materials is suitable for being fiberized by internal centrifugation when the temperature (T log 3) of the glass bath, for a dynamic viscosity of Log 3 Poises, is less than 1400° C., preferentially less than 1300° C., more preferentially less than 1250° C., better still less than 1200° C., or even less than 1100° C. and that the difference (T log 3−Tliq) between the temperature corresponding to the Log 3 Poises viscosity value and the crystallization temperature of the glass (also known as the liquidus temperature) is greater than 35° C., preferentially greater than 70° C., more preferentially greater than 100° C., better still greater than 110° C., or even greater than 120° C., for example greater than 130° C. As is well known in the field of glass melting, dynamic viscosity is expressed in Log N Poises, which corresponds to 10N Poises (and 1 Poise=0.1 Pa·s), each viscosity value corresponding to a given glass bath temperature. Dynamic viscosity can be measured using a glass viscometer.

The invention is based on the concept consisting of introducing a rock wool recyclate into a composition of raw materials intended to be melted and then fiberized by external centrifugation, a fiberizing method usually reserved for the production of mineral wool, in particular glass wool. The addition of rock wool recyclate which, by its composition, is not initially suitable for fiberizing by internal centrifugation, introduces an additional technical difficulty for a skilled person in charge of melting and fiberizing. Despite these technical difficulties, such an addition allows an operator to gain flexibility in the choice of raw materials to be used, and thus to seize opportunities that can be temporarily offered by recycling channels arranged in the vicinity of the melting and fiberizing facilities.

The solution proposed by this invention also has the advantage of being both economical and ecological. Indeed, glass wool is usually manufactured from natural raw materials such as feldspar, dolomite and lime, which are costly and/or emit CO₂ and/or penalize the melting yield of the glass composition. The use of rock wool recyclate as a source rich in Al₂O₃, CaO and MgO reduces the use of these raw materials. The lower amounts of CO₂ and water emitted during the manufacture of glass wool using recycled rock wool further help to improve the material yield, i.e. the ratio between the amount of raw materials introduced and the amount of molten glass obtained after melting the composition of raw materials. The use of rock wool also reduces the energy required to melt the composition of raw materials.

Thus, the present invention also relates to a use of a rock wool recyclate as a source of Al₂O₃, CaO and MgO for the manufacture of a mineral wool, in particular glass wool.

According to a particular embodiment, said composition of raw materials comprises a mass percentage of rock wool from 2% to 38%, for example from 5% to 35%, from 10% to 30%, from 15% to 25%, from 20% to 38% or from 25% to 38%.

According to a particular embodiment, said composition of raw materials comprises a mass percentage of rock wool recyclate from 1% to 9%.

According to another particular embodiment, said composition of raw materials comprises a mass percentage of rock wool recyclate from 10% to 40%.

The rock wool recyclate includes rock wool, but also derived forms such as a rock wool ground or heated to form glass rock agglomerates.

According to a particular embodiment, the rock wool recyclate added to said composition of raw materials is at least a partially bonded rock wool. Within the meaning of the invention, the term “bonded rock wool” herein refers to the mineral wool consisting of mineral fibers having on their surface an organic binder, which is already crosslinked. Alternatively, the rock wool can be coated with a thin layer of sizing or lubricant.

According to a particular embodiment, the rock wool recyclate added to said composition of raw materials is at least a partially virgin rock wool. Within the meaning of the invention, the expression “virgin rock wool” refers to the rock wool obtained by external centrifugation, the fibers of which are not bonded to one another by means of an organic binder, as opposed to a bonded rock wool. Such virgin rock wool is typically used as blown-in wool for attic insulation, or sprayed-in wool for underfloor insulation.

According to a particular embodiment, the rock wool recyclate has a chemical composition comprising the following constituents, as a mass percentage:
SiO2: 30 to 50%,
Al2O3: 10 to 22%,
CaO+MgO: 20 to 45%,
Fe2O3: 0 to 20%, for example 3 to 20%,
Na2O+K2O: 0 to 10%, for example 0 to 8%, and
B2O3: 0 to 1%.

According to a more particular embodiment, the rock wool recyclate has a chemical composition comprising the following constituents, as a mass percentage:
SiO2: 40 to 48%,
Al2O3: 14 to 19% (for example 15 to 17%),
CaO+MgO: 24 to 33%,
Fe2O3: 3 to 20%,
Na2O+K2O: 0 to 8% (for example 2 to 8%), and
B2O3: 0 to 1%.

For example, the rock wool recyclate may have a chemical composition comprising the following constituents, as a mass percentage:
SiO2: 30 to 50%,
Al2O3: 10 to 22%,
CaO+MgO: 20 to 45%,
Fe2O3: 3 to 20%,
Na2O+K2O: 0 to 5%, or even 0 to 4%, and
B2O3: 0 to 1%.

According to an even more particular embodiment, the rock wool recyclate has a chemical composition comprising the following constituents, as a mass percentage:
SiO2: 40 to 48%,
Al2O3: 14 to 19%, for example 15 to 17%,
CaO+MgO: 24 to 33%,
Fe2O3: 5 to 12%,
Na2O+K2O: 2 to 4%, and
B2O3: 0 to 1%.

The detailed description refers to three example compositions of rock wool recyclates, under the names “rock wool 1”, “rock wool 2” and “rock wool 3” (compositions described in the examples below), which fall within these compositional ranges and are commonly used in the insulation industry. Such waste can therefore be collected at numerous production sites and/or construction/demolition sites.

According to a particular embodiment, the rock wool recyclate has a boron-free composition. Such a composition is notably useful in the insulation industry.

According to a particular embodiment, said composition of raw materials comprises household cullet and/or flat glass cullet. Adding household cullet and/or flat glass makes it possible to increase flexibility in the choice of raw materials to be used.

According to a particular embodiment, said composition of raw materials comprises from 0% to 20%, for example from 0% to 15% or even from 0% to 10% Fe2O3, by mass with respect to the mass of solids in the composition of raw materials. According to a particular embodiment, said composition of raw materials comprises at least 2%, preferentially at least 5% Fe2O3, by mass with respect to the mass of solids in the composition of raw materials. An increased content of Fe2O3 in the composition of raw materials makes it possible, after fiberizing, to increase the maximum service temperature of the fiber obtained. In other words, such a fiber has better resistance to higher temperatures.

According to a particular embodiment, said composition of raw materials comprises from 0% to 25%, for example from 0% to 15% or even from 0% to 10% Al2O3, by mass with respect to the mass of solids in the composition of raw materials. According to a particular embodiment, said composition of raw materials comprises at least 2%, more preferentially at least 5%, more preferentially at least 10%, most preferentially at least 20% Al2O3, by mass with respect to the mass of solids in the composition of raw materials.

According to a particular embodiment, said composition of raw materials comprises from 20% to 75%, for example from 30% to 75% or from 20% to 60% SiO2, by mass with respect to the mass of solids in the composition of raw materials.

More particularly, the composition of raw materials can comprise from 37% to 75% (for example from 37% to 60%, or from 50% to 75%) SiO2, from 0% to 8% (for example from 0% to 6%) Al2O3, and from 0% to 3% Fe2O3, by mass with respect to the mass of solids in the composition of raw materials.

Alternatively, the composition of raw materials can comprise from 26% to 55% (for example from 26% to 41% or from 35% to 55%) SiO2, from 12% to 27% (for example from 16% to 27% or from 12% to 24%) Al2O3, and from 0% to 15% (for example from 0% to 12%) Fe2O3, by mass with respect to the mass of solids in the composition of raw materials.

According to a particular embodiment, the mineral wool (i.e. target mineral wool) has a chemical composition which comprises the following constituents, as a mass percentage:
SiO2: 30 to 75%,
Al2O3: 0 to 30%,
CaO+MgO: 3 to 45%,
Fe2O3: 0 to 20%,
Na2O+K2O: 4 to 20%,
B2O3: 0 to 14%, and
MnO: 0 to 4%.

According to a particular embodiment, the mineral wool (i.e. target mineral wool) has a chemical composition which comprises the following constituents, as a mass percentage:
SiO2: 30 to 75%, for example 39 to 70%,
Al2O3: 0 to 30%, for example 1 to 25%,
CaO+MgO: 5 to 45%, for example 9 to 22%,
Fe2O3: 0 to 20%, for example 0 to 10%,
Na2O+K2O: 0 to 20%, for example 1 to 18%,
B2O3: 0 to 14%, and
MnO: 0 to 4%.

According to a particular embodiment, the mineral wool (i.e. target mineral wool) has a chemical composition which comprises the following constituents, as a mass percentage:
SiO2: 30 to 75%, for example 39 to 70%,
Al2O3: 0 to 30%, for example 1 to 25%,
CaO+MgO: 5 to 45%, for example 5 to 18%,
Fe2O3: 0 to 20%, for example 0 to 10%,
Na2O+K2O: 4 to 20%, for example 5 to 18%, or even 9 to 18%,
B2O3: 0 to 14%, and
MnO: 0 to 4%.

According to a particular embodiment, the mineral wool (i.e. target mineral wool) has a chemical composition which comprises the following constituents, as a mass percentage:
SiO2: 35 to 75%,
Al2O3: 0 to 27%,
CaO+MgO: 5 to 45%, for example 5 to 18%,
Fe2O3: 0 to 15%,
Na2O+K2O: 4 to 20%, or even 9 to 18%,
B2O3: 0 to 14%, and
MnO: 0 to 4%.

For example, mineral wool (i.e. target mineral wool) may have a chemical composition that comprises the following constituents, as a mass percentage:
SiO2: 30 to 75%, for example 39 to 70%,
Al2O3: 0 to 30%, for example 1 to 25%,
CaO+MgO: 5 to 18%,
Fe2O3: 0 to 20%, for example 0 to 10%,
Na2O+K2O: 4 to 20%,
B2O3: 0 to 14%, and
MnO: 0 to 4%.

More particularly, the mineral wool (i.e. target mineral wool) may have a chemical composition that comprises the following constituents, as a mass percentage:
SiO2: 50 to 75%, for example 60 to 70%,
Al2O3: 0 to 8%, for example 1 to 5%,
CaO+MgO: 5 to 20%, for example 9 to 14%,
Fe2O3: 0 to 3%, for example 0 to 1%,
Na2O+K2O: 6 to 20%, for example 12 to 18%,
B2O3: 0 to 14%, and
MnO: 0 to 4%.

Alternatively, the mineral wool (i.e. target mineral wool) may have a chemical composition that comprises the following constituents, as a mass percentage:
SiO2: 35 to 55% (for example 40 to 50%),
Al2O3: 16 to 27% (for example 17 to 25%),
CaO+MgO: 3 to 30% (for example 3 to 18%, or even 14 to 22%),
Fe2O3: 0 to 15% (for example 1 to 8%),
Na2O+K2O: 5 to 17% (for example 7 to 17%, or even 9 to 17% or even 10 to 14%), and
B2O3: 0 to 5% (for example 0 to 2%),
preferably: SiO2: 35 to 55%, Al2O3: 16 to 27%, CaO+MgO: 3 to 30% (for example 3 to 18%), Fe2O3: 0 to 15%, Na2O+K2O: 7 to 17%, and B2O3: 0 to 5%;
better still: SiO2: 35 to 55%, Al2O3: 16 to 27%, CaO+MgO: 3 to 30% (for example 3 to 18%), Fe2O3: 0 to 15%, Na2O+K2O: 9 to 17%, and B2O3: 0 to 5%.

It should be noted that a skilled person has general knowledge for, on the basis of routine tests, adapting the rest of the composition of raw materials so that the latter meets the technical specifications of fiberizing by internal centrifugation.

The invention further relates to a method comprising a step of melting such a composition of raw materials in a glass furnace as defined in the present application.

In a known manner, such a composition of raw materials can be melted in a glass furnace with submerged and/or non-submerged burners, in an electric furnace, and/or in a hybrid furnace implementing at least one burner and electrodes. At the outlet of the furnace, the molten composition may either be immediately fiberized by internal centrifugation, or be cooled and transformed into cullet, to be later (subsequently) re-melted and fiberized by internal centrifugation to obtain a mineral wool.

The invention further relates to a method for manufacturing mineral wool characterized in that it implements such a melting method and a subsequent step of fiberizing the molten composition of raw materials by internal centrifugation.

The invention further relates to a mineral wool obtained according to such a manufacturing method.

A general method that can be implemented by a furnace operator to prepare a composition of raw materials according to the invention is detailed in the rest of the description.

During a first step, a target composition that satisfies the viscosity criteria for being fiberized by internal centrifugation is selected. For the purposes of the invention, such a composition is suitable for being fiberized by internal centrifugation if the temperature (T log 3) of the glass melt, for a dynamic viscosity of Log 3 Poises, is less than 1400° C., preferentially less than 1300° C., more preferentially less than 1250° C., better still less than 1200° C., and that the difference (T log 3−Tliq) between the temperature corresponding to the Log 3 Poises viscosity value and the glass crystallization temperature (also known as the liquidus temperature) is greater than 35° C., preferentially greater than 70° C., more preferentially greater than 100° C.

In order to assist in the selection of this target composition, a furnace operator uses models that draw a relationship between the chemical composition and the dynamic viscosity of a mixture, such as those commonly used in the glass industry.

In an industrial context and in a known manner, other considerations can also be taken into account in the selection of the target composition, such as the final cost of the composition, the energy required for the melting thereof, and compliance with certain chemical compound concentration ranges.

During a second step, the operator prepares its mixture by taking into account the respective chemical composition of each of the raw materials at its disposal, and adjusts the relative proportions of each of these raw materials to obtain the target composition.

Alternatively or in combination, these raw materials can be in the form of pure oxides, salts (such as sodium carbonate, potash, or borax), natural raw materials (siliceous sands, dolomite, limestone, sterile, slag, bauxite, feldspar, anorthosite, felite, etc.) which are already combinations of oxides, waste glass and/or rock wool, which may be derived from the production of said fibers or from worksites (construction or demolition), optional liquid or solid fuels (composite or non-composite plastic material, organic materials, coal), and of any type of glass cullet. Also included are recyclable materials containing combustible (organic) elements such as for example, mineral fibers (of the type used in reinforcement), glazings laminated with sheets of polyvinyl butyral polymers such as windshields, glass bottles (household cullet), or any type of “composite” material combining glass and plastic materials such as certain bottles. Also recyclable are “glass-metal composites or metal compounds” such as functionalized glazings with coatings containing metals.

It should be noted that, according to an alternative embodiment, an operator begins by taking into account the respective composition of each of the raw materials at its disposal for subsequently adjusting the relative proportions thereof and, empirically, determining and obtaining a target composition which, on the basis of the models at its disposal, meets the viscosity criteria for being fiberized by internal centrifugation.

Once the target composition is obtained, it is loaded into a glass furnace in order to be melted therein. The composition thus melted is subsequently fiberized by internal centrifugation in order to form a mineral wool.

### EXAMPLES

Further features and advantages of the invention will become apparent from the following examples, which are given by way of illustration only and are not intended to limit the scope of the invention, as defined by the appended claims.

### Example 1: Low-Alumina Glass Fibers

The four target compositions of low-alumina glass wool described in Table 1 below are selected by a furnace operator.

TABLE 1

| | Target compositions | | | |
|---|---|---|---|---|
| | 1 (% m.) | 2 (% m.) | 3 (% m.) | 4 (% m.) |
| SiO2 | 65 | 65 | 62.3 | 65.1 |
| Al2O3 | 3.6 | 2.3 | 2.5 | 2.15 |
| CaO | 6.4 | 8.2 | 9.8 | 7.5 |
| MgO | 4.3 | 4.3 | 3.3 | 2.7 |
| Fe2O3 | 0.74 | 0 | 0.04 | 0.52 |
| Na2O | 14.8 | 15.4 | 14.5 | 16.6 |
| K2O | 1.8 | 0.9 | 0.5 | 0.65 |
| B2O3 | 0 | 3.9 | 6.8 | 4.2 |
| MnO | 3.01 | 0 | 0 | 0.27 |
| Tliq exp (° C.) | 1020 | 914 | 947 | 905 |
| Tlog3 exp | 1183 | 1095 | 1053 | 1065 |
| (° C.) | | | | |
| Tlog3 − Tliq | 163 | 182 | 106 | 147 |
| (° C.) | | | | |

% m. : mass %

For these four target compositions, the liquidus temperature (Tliq) can be approximated from experimental measurements available in the literature and the T log 3 temperature can be calculated from the Fluegel model (A. Fluegel, “Glass Viscosity Calculation Based on a Global Statistical Modeling Approach”, Glass Technol.: Europ. J. Glass Sci. Technol. A, vol. 48, 2007, no. 1, p 13-30.). The values given in Table 1 hereinbefore show that all four target compositions are suitable for fiberizing by internal centrifugation.

To obtain these target compositions, the operator notably has the raw materials of dolomite, sand, sodium carbonate, borax, raw limestone, felite, potash, manganese and rock wool recyclate. The compositions of three rock wools are detailed in Table 2 below.

TABLE 2

| | Rock wool 1 | Rock wool 2 | Rock wool 3 |
|---|---|---|---|
| | (% m.) | (% m.) | (% m.) |
| SiO2 | 42.6 | 46.7 | 41.8 |
| Al2O3 | 16.6 | 15.2 | 15.4 |
| CaO | 19.5 | 14.6 | 24.9 |
| MgO | 12.3 | 11.1 | 7.2 |
| Fe2O3 | 5.5 | 7.8 | 5.5 |
| Na2O | 1.6 | 2.0 | 1.5 |
| K2O | 0.9 | 1.0 | 1.3 |
| B2O3 | <1 | — | — |

The mass proportions (% m) of each of the raw materials are adjusted, as mentioned in Table 3 below, to obtain the target compositions (maximum of 0.2% deviation with respect to the target composition for majority oxides (i.e. target greater than 1% by mass) and maximum of 0.8% deviation with respect to the target composition for minority oxides (i.e. target less than 1% by mass)).

TABLE 3

| | 1 (% m.) | | 2 (% m.) | | 3 (% m.) | | 4 (% m.) | | |
|---|---|---|---|---|---|---|---|---|---|
| Rock wool 1 | 20 | — | 14 | — | 15 | — | — | — | — |
| Rock wool 2 | — | 15 | — | 10 | — | 10 | — | — | — |
| Rock wool 3 | — | — | — | — | — | — | 1 | 2 | 4 |
| Sand | 56.5 | 54.2 | 59.2 | 57.9 | 56.1 | 54.5 | 9.2 | 9.3 | 9.3 |
| Sodium carbonate | 24.7 | 24.6 | 22.9 | 22.9 | 19.2 | 19.1 | 7.0 | 7.1 | 7.3 |
| Borax pentahydrate | — | — | 8 | 8 | 14 | 14 | 8.3 | 8.3 | 8.3 |
| Raw limestone | — | — | 3.4 | 4.1 | 8.9 | 9.7 | 0.9 | 0.7 | — |
| Felite | — | 5.8 | — | 3.9 | — | 4.9 | — | — | — |
| Dolomite | 4.5 | 6.5 | 6.4 | 7.9 | 3.5 | 5.3 | 0.3 | — | — |
| Potash | 2.3 | 2 | 1.1 | 0.9 | 0.5 | 0.3 | — | — | — |
| Manganese | 3.8 | 3.8 | — | — | — | — | 0.5 | 0.5 | 0.5 |
| Feldspar | — | — | — | — | — | — | 5.7 | 5.0 | 3.5 |
| Internal cullet (glass waste) | — | — | — | — | — | — | 5.6 | 5.6 | 5.6 |
| Flat glass cullet | — | — | — | — | — | — | 61.5 | 61.5 | 61.5 |

Starting from each of the compositions of rock wool 1, 2 and 3, by adding suitable raw materials thereto, the inventors have thus been able to obtain target compositions of low-alumina wools which have a mass concentration of rock fibers of 1 to 20% in the vitrifiable mixture, while satisfying the criteria necessary for fiberizing by internal centrifugal. The inventors have also demonstrated that the use of the rock wool makes it possible to reduce or even do without certain CO2-emitting raw materials (e.g. limestone and dolomite: 0% for target composition 4 using 4% rock wool) or costly materials (e.g. feldspar).

### Example 2: High-Alumina Glass Fibers

The following two high-alumina glass wool target compositions described in Table 4 below are selected by a furnace operator.

TABLE 4

| | Target composition 5 | Target composition 6 |
|---|---|---|
| | (% m.) | (% m.) |
| SiO2 | 48.6 | 43.0 |
| Al2O3 | 17.8 | 23.3 |
| CaO | 15.5 | 14.2 |
| MgO | 5.2 | 1.75 |
| Fe2O3 | 2.2 | 5.65 |
| Na2O | 7.2 | 6.6 |
| K2O | 3.0 | 4.0 |
| Tliq exp (° C.) | 1154 | 1170 |
| Tlog3 exp (° C.) | 1189 | 1215 |
| Tlog3 − Tliq (C) | 35 | 45 |

For these two target compositions, the liquidus temperature (Tliq) and the T log 3 temperature can be determined as shown in Example 1. The values given in Table 4 hereinbefore show that both target compositions are suitable for fiberizing by internal centrifugation.

To obtain these target compositions, the operator has the raw materials notably of dolomite, bauxite, limestone, potash, sand, sodium carbonate, iron oxide and rock wool recyclate. The compositions of two rock wools are detailed in Table 2 hereinbefore.

The mass proportions (% m) of each of the raw materials are adjusted, as mentioned in Table 5 below, for obtaining the target composition.

TABLE 5

| | |
|---|---|
| 5 (% m.) | 6 (% m.) |

| | | | | |
|---|---|---|---|---|
| Rock wool 1 | 37 | — | 13 | — |
| Rock wool 2 | — | 25 | — | 15 |
| Bauxite | 16.5 | 19.8 | 30 | 29.7 |
| Dolomite | 2.2 | 10.3 | — | — |
| Limestone | 13.6 | 15.5 | 10.6 | 21.2 |
| Potash | 3.8 | 3.9 | 5.5 | 5.4 |
| Sand | 29.5 | 32.8 | 31.3 | 29.9 |
| Sodium carbonate | 11.5 | 11.6 | 11 | 10.8 |
| Iron oxide | — | — | 4.5 | 4.1 |

Starting from each of the compositions of rock wool 1 and 2, by adding suitable raw materials thereto, the inventors have thus been able to obtain target compositions that have a mass concentration of rock fibers of 13 to 37%, while satisfying the criteria necessary for fiberizing by internal centrifugation.

### Example 3: Economic and Energy Savings

Table 6 below exemplifies the raw material (“RM”) savings achieved by the introduction of rock wool recyclate, per tonne of glass produced (i.e. after melting the composition of raw materials, and before fiberization) for the composition of raw materials used to obtain target composition 4 (see Table 3).

TABLE 6

| | Target composition 4 | | | |
|---|---|---|---|---|
| | 0%* | 1%* | 2%* | 4%* |
| Total RM added (kg)/ | 1077.1 | 1074.8 | 1072.7 | 1071.3 |
| tonne of glass | | | | |
| RM saving vs. 0% rock | — | −0.2% | −0.4% | −0.5% |
| wool recyclate | | | | |
| RM saving vs. amount of | — | −21.3% | −20.6% | −13.5% |
| rock wool recyclate | | | | |

*Mass percentage of rock wool 3 recyclate in the composition of raw materials (see Table 3)

The use of rock wool in a composition of raw materials for the manufacture of a mineral wool improves material yield. For example, to form one tonne of molten glass (which leads to a mineral wool after fiberization) with target composition 4, 1071.3 kg of raw materials are required with 4% rock wool, compared with 1077.1 kg without rock wool.

Table 7 below exemplifies the savings in terms of CO2 emissions (scope 1) per tonne of glass produced, for the composition of raw materials used to obtain target composition 4 (see Table 3), considering the three main contributors to CO2 emissions (scope 1):
dolomite, which has a CO2 emission factor of 0.47 t CO2/t RM,
sodium carbonate, which has a CO2 emission factor of 0.41 t CO2/t RM,
raw limestone, which has a CO2 emission factor of 0.41 t CO2/t RM.

TABLE 7

Target composition 4

| | 0%* | 1%* | 2%* | 4%* |
|---|---|---|---|---|
| kg CO2/t molten glass | 38.5 | 36.5 | 34.5 | 31.9 |
| Saving in tons of CO2 | — | −5% | −10% | −17% |
| vs. 0% | | | | |
| Saving in tons of CO2 | — | −19% | −19% | −15% |
| vs. amount of recycled | | | | |
| rock wool | | | | |

*Mass percentage of rock wool 3 recyclate in the composition of raw materials (see Table 3)

The use of rock wool in a composition of raw materials for the manufacture of a mineral wool reduces CO2 emissions (scope 1). For example, to form molten glass (which results in a mineral wool after fiberization) with target composition 4, the introduction of 1% to 4% rock wool reduces CO2 emissions by 5% to 17%, notably CO2 (scope 1).

1. A composition of raw materials suitable for being melted and fiberized by internal centrifugation in order to obtain a mineral wool, wherein said composition comprises from 1% to 50% by mass of rock wool recyclate.

2. The composition of raw materials according to claim 1, comprising at least 2% Fe2O3 by mass with respect to a mass of solids in the composition of raw materials.

3. The composition of raw materials according to claim 1, comprising at least 2% Al2O3 by mass with respect to a mass of solids in the composition of raw materials.

4. The composition of raw materials according to claim 1, wherein the rock wool recyclate has a chemical composition which comprises the following constituents, in mass percentage:
SiO2: 30 to 50%,
Al2O3: 10 to 22%,
CaO+MgO: 20 to 45%,
Fe2O3: 0 to 20%,
Na2O+K2O: 0 to 8%,
B2O3: 0 to 1%.

5. The composition of raw materials according to claim 1, wherein the rock wool recyclate has a chemical composition which comprises the following constituents, in mass percentage:
SiO2: 30 to 50%,
Al2O3: 10 to 22%,
CaO+MgO: 20 to 45%,
Fe2O3: 3 to 20%,
Na2O+K2O: 0 to 8%,
B2O3: 0 to 1%.

6. The composition of raw materials according to claim 4, wherein the rock wool recyclate has a chemical composition which comprises the following constituents, in mass percentage:
SiO2: 40 to 48%,
Al2O3: 14 to 19%,
CaO+MgO: 24 to 33%,
Fe2O3: 5 to 12%,
Na2O+K2O: 2 to 4%,
B2O3: 0 to 1%.

7. The composition of raw materials according to claim 1, comprising 1 to 40% by mass of rock wool recyclate.

8. The composition of raw materials according to claim 1, wherein said mineral wool has a chemical composition which comprises the following constituents, in mass percentage:
SiO2: 30 to 75%,
Al2O3: 0 to 30%,
CaO+MgO: 5 to 45%,
Fe2O3: 0 to 20%,
Na2O+K2O: 4 to 20%,
B2O3: 0 to 14%,
MnO: 0 to 4%.

9. The composition of raw materials according to claim 1, wherein said mineral wool has a chemical composition which comprises the following constituents, in mass percentage:
SiO2: 30 to 75%,
Al2O3: 0 to 30%,
CaO+MgO: 5 to 18%,
Fe2O3: 0 to 20%,
Na2O+K2O: 4 to 20%,
B2O3: 0 to 14%,
MnO: 0 to 4%.

10. The composition of raw materials according to claim 1, wherein said mineral wool has a chemical composition which comprises the following constituents, in mass percentage:
a) SiO2: 50 to 75%,
Al2O3: 0 to 8%,
CaO+MgO: 5 to 20%,
Fe2O3: 0 to 3%,
Na2O+K2O: 6 to 20%,
B2O3: 0 to 14%,
MnO: 0 to 4%;
or
b) SiO2: 35 to 55%,
Al2O3: 16 to 27%,
CaO+MgO: 3 to 30%,
Fe2O3: 0 to 15%,
Na2O+K2O: 5 to 17%,
B2O3: 0 to 5%.

11. The composition of raw materials according to claim 1, wherein said mineral wool has a chemical composition which comprises the following constituents, in mass percentage:
SiO2: 35 to 55%,
Al2O3: 16 to 27%,
CaO+MgO: 3 to 18%,
Fe2O3: 0 to 15%,
Na2O+K2O: 9 to 17%,
B2O3: 0 to 5%.

12. A method comprising melting in a glass furnace, a composition of raw materials according to claim 1.

13. The method according to claim 12, further comprising fiberizing by internal centrifugation a molten composition of raw materials.

14. A mineral wool obtained according to the method of claim 13.

15. A method, comprising using rock wool recyclate as a source of Al₂O₃, CaO and MgO in the manufacture of a mineral wool.
